(19) United States
(12) Patent Application Publication
(10) Pub. No.: US 2025/0355494 A1
(43) Pub. Date: Nov. 20, 2025

(54) SYSTEM AND METHOD FOR DYNAMICALLY UPDATING A BACKGROUND IN A VIDEOCONFERENCING APPARATUS

(71) Applicant: Mitel Networks Corporation, Kanata (CA)

(72) Inventors: Tejas Kanduri Aswathanarayana Murthy, Bangalore (IN); Logendra Naidoo, Ottawa (CA)

(73) Assignee: Mitel Networks Corporation, Kanata (CA)

(21) Appl. No.: 19/287,689

(22) Filed: Jul. 31, 2025

Related U.S. Application Data
(63) Continuation-in-part of application No. 18/228,488, filed on Jul. 31, 2023.

(30) Foreign Application Priority Data
Jul. 15, 2025 (EP) 25189748.4

(51) Int. Cl. G06F 3/01

(52) U.S. Cl. CPC G06F 3/013; G06F 3/012; G06F 2203/011

(57) ABSTRACT

A videoconferencing system and method are configured to select a virtual background for a participant of a videoconference. The system comprises a user analysis engine configured to receive and analyze a video feed to detect one or more physical characteristics of a first participant of a videoconference and to infer a particular cognitive or emotional state of the first participant from the detected one or more physical characteristics. The system comprises a background adjustment engine is configured to select a virtual background displayed with the first video feed based on the particular cognitive or emotional state of the first participant.

### CROSS REFERENCE TO RELATED APPLICATIONS

This application is a continuation-in-part of and claims priority to U.S. Non-Provisional application Ser. No. 18/228,488, filed Jul. 31, 2023, and entitled “SYSTEM AND METHOD FOR PLACING ADVERTISING CONTENT AS A VIRTUAL BACKGROUND IN A VIDEOCONFERENCING APPARATUS. This application also claims benefit of and priority to European Patent Application No. EP25189748.4, filed Jul. 15, 2025, entitled “SYSTEM AND METHOD FOR DYNAMICALLY UPDATING A BACKGROUND IN A VIDEOCONFERENCING APPARATUS. The contents of each aforementioned applications are incorporated herein by reference to the extent such contents do not conflict with the present disclosure.

### BACKGROUND

Most collaboration tools support videoconferencing, provide work from home options, and videoconferencing usage has increased over the past several years. Video conferencing systems rely on static virtual backgrounds, offering minimal personalization beyond aesthetic preferences or basic privacy features like background blurring. Existing systems lack the capability to dynamically adapt to the individual emotional and cognitive states of participants during a meeting.

Particularly for users with mental health sensitivities or those prone to cognitive overload, static backgrounds can add to discomfort, distraction, or reduced engagement.

### SUMMARY

A first aspect of this disclose provides a videoconferencing system configured to generate a video conference including a background for one or more participants of the videoconference, the videoconferencing system comprising: a background adjustment engine; a user analysis engine; and a videoconferencing server in communication with the background adjustment engine and configured to generate a videoconference and communicate the video conference to one or more conference participant devices wherein the user analysis engine is configured to: receive a video feed from each of the one or more participant devices; analyze a first video feed from a first of the one or more participant devices to detect one or more physical characteristics of a first participant; and infer a particular cognitive or emotional state of a first participant based on the detected one or more physical characteristics, and wherein the background adjustment engine is configured to select a virtual background to be displayed with the first video feed based on the particular cognitive or emotional state of the first participant.

The background adjustment engine may be configured to obtain one or more images from a backgrounds database, the one or more images being selected based on the particular cognitive or emotional state of the first participant.

The background adjustment engine may be configured to select a virtual background displayed with the first video feed by instructing the videoconferencing server to display one of the one or more images obtained from the backgrounds database as the virtual background displayed with the first video feed.

The one or more images may be selected using metadata indicating that the one or more images are considered beneficial for the particular cognitive or emotional state.

The user analysis engine may be configured to infer the particular cognitive or emotional state of the first participant by associating the detected one or more physical characteristics of a first participant with cognitive fatigue, stress, confusion, distractedness and/or nervousness.

The user analysis engine may be configured to detect the one or more physical characteristics of a first participant by measuring a blink rate and/or a blink duration.

In response to detecting a variation in blink rate and/or blink duration or a blink rate and/or duration which is above a high threshold, the user analysis engine may be configured to infer a state of cognitive fatigue and/or stress of the first participant; and the background adjustment engine may be configured to select a virtual background to be displayed with the first video feed based on the inferred state of cognitive fatigue and/or stress.

The user analysis engine may be configured to detect the one or more physical characteristics of a first participant by tracking saccadic eye movements.

In response to detecting saccadic eye movements which are erratic and/or high in frequency, the user analysis engine may be configured to infer a state of distractedness, stress or hyperstimulation; and the background adjustment engine may be configured to select a virtual background to be displayed with the first video feed based on the inferred state of distractedness, stress or hyperstimulation.

The user analysis engine may be configured to detect the one or more physical characteristics of a first participant by detecting changes in facial muscle tension.

In response to detecting elevated or prolonged tension in the muscles around the eyes and/or jaw of the first participant, the user analysis engine may be configured to infer a state of stress or confusion; and the background adjustment engine may be configured to select a virtual background to be displayed with the first video feed based on the inferred state of stress or confusion.

The user analysis engine may be configured to detect the one or more physical characteristics of a first participant by determining a gaze direction or change in a gaze direction.

In response to detecting that the gaze direction of the first participant is away from the screen, the user analysis engine may be configured to infer a state of distractedness; and the background adjustment engine may be configured to select a virtual background to be displayed with the first video feed based on the inferred state of distractedness.

The user analysis engine may be configured to detect the one or more physical characteristics of a first participant by detecting repetitive gestures and in response to infer a state of distractedness or nervousness; and the background adjustment engine may be configured to select a virtual background to be displayed with the first video feed based on the inferred state of distractedness or nervousness.

The user analysis engine may be configured to detect the one or more physical characteristics of a first participant by detecting a shift in body posture.

In response to detecting a shift in the body posture of the first participant to leaning backwards, the user analysis engine may be configured to infer a state of distractedness and/or disinterest of the first participant; and the background adjustment engine is configured to obtain an image from a backgrounds database, based on the inferred state of distractedness and/or disinterest.

The user analysis engine may be configured to detect the one or more physical characteristics of a first participant by detecting adjustments in head position and in response to infer a state of confusion; and the background adjustment engine may be configured to select a virtual background to be displayed with the first video feed based on the inferred state of confusion.

The user analysis engine may be configured to: compare the detected one or more physical characteristics of the first participant with one or more corresponding baseline metrics for the first participant; and infer the particular cognitive or emotional state of the first participant when the detected one or more physical characteristics differ from the one or more corresponding baseline metrics by a predetermined factor.

The videoconferencing server may also be in communication with the user analysis engine and with a conferencing device of each of the one or more conference participants.

The video feed may be a live video feed and wherein the background adjustment engine may be configured to replace a live feed background of the first live video feed with a virtual background selected based on the particular cognitive or emotional state of the first participant.

In response to the user analysis engine inferring a particular cognitive or emotional state of a first participant, the background adjustment engine may be configured to change a background displayed with a video feed of another of the one or more participants of the videoconference.

A second aspect of this disclose provides a videoconferencing method operable on a video conferencing system, wherein the videoconferencing method is configured to generate a video conference including a background for one or more participants of the videoconference and wherein the videoconferencing system comprises a videoconferencing server in communication with a background adjustment engine, and a user analysis engine, the method comprising the steps of: the videoconferencing server generating a videoconference and communicating the video conference to one or more conference participant devices; the user analysis engine receiving a video feed from each of the one or more participant devices; the user analysis engine analyzing a first video feed from a first of the one or more participant devices to detect one or more physical characteristics of a first participant; the user analysis engine inferring a particular cognitive or emotional state of a first participant based on the detected one or more physical characteristics; and the background adjustment engine selecting a virtual background to be displayed with the first video feed based on the particular cognitive or emotional state of the first participant.

A third aspect of this disclose provides a videoconferencing system configured to generate a video conference including a background for one or more participants of the videoconference, the videoconferencing system comprising: a background adjustment engine; a user analysis engine; and a videoconferencing server (12, 52) in communication with the background adjustment engine (14) and configured to generate a videoconference and communicate the video conference to one or more conference participant devices, wherein the user analysis engine is configured to: receive a video feed from each of the one or more participant devices; analyze a first video feed from a first of the one or more participant devices to detect one or more physical characteristics of a first participant; and infer a negative cognitive or emotional state of a first participant based on the detected one or more physical characteristics, wherein the background adjustment engine is configured to change a virtual background to be displayed with the first video feed in response to the user analysis engine inferring the negative cognitive or emotional state, and wherein the background adjustment engine is configured not to change the virtual background to be displayed with the first video feed in response to the user analysis engine not inferring the negative cognitive or emotional state.

### BRIEF DESCRIPTION OF THE DRAWING FIGURES

The subject matter of the present disclosure is particularly pointed out and distinctly claimed in the concluding portion of this specification. A more complete understanding of the present disclosure, however, may best be obtained by referring to the detailed description and claims when considered in connection with the drawing figures, wherein like numerals denote like elements and wherein:

FIG. 1 illustrates a videoconferencing system according to aspects of this disclosure.

FIG. 2 illustrates an alternate videoconferencing system according to aspects of this disclosure.

FIG. 3 illustrates a flowchart according to aspects of this disclosure.

FIG. 4 illustrates a sequence diagram according to aspects of this disclosure.

It will be appreciated that elements in the figures are illustrated for simplicity and clarity and have not necessarily been drawn to scale. For example, the dimensions of some of the elements in the figures may be exaggerated relative to other elements to help to improve understanding of illustrated embodiments of the present invention.

### DETAILED DESCRIPTION

The present disclosure is of a system and method for analyzing a video feed for each participant of a videoconference and that is configured to dynamically update the videoconference background of participants based on the analysis of the video feed of a particular participant. Unlike previous meeting functions that apply virtual backgrounds primarily for privacy, aesthetic customization, or advertising purposes, this approach focuses on enhancing user well-being and engagement through real-time personalization based on subtle behavioral cues.

As used herein, the terms application, module, analyser, and the like can refer to computer program instructions, encoded on computer storage medium for execution by, or to control the operation of, data processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of the substrates and devices. Moreover, while a computer storage medium is not a propagated signal, a computer storage medium can be a source or destination of computer program instructions encoded in an artificially-generated propagated signal. The computer storage medium is non-transitory and can also be, or be included in, one or more separate physical components or media (e.g., solid-state memory that forms part of a device, disks, or other storage devices).

As used herein, “engine” refers to a data-processing apparatus, such as a processor, configured to execute computer program instructions, encoded on computer storage medium, wherein the instructions control the operation of the engine. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. Each engine may also comprise one or more memories which may be read only or read/write memories.

A computer storage medium can be, or be included in, a computer-readable storage device, a computer-readable storage substrate, a random or serial access memory array or device, or a combination of one or more of the substrates and devices. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., solid-state memory that forms part of a device, disks, or other storage devices). In accordance with examples of the disclosure, a non-transient computer readable medium containing program can perform functions of one or more methods, modules, engines and/or other system components as described herein.

As used herein, “database” refers to any suitable database for storing information, electronic files or code to be utilized to practice embodiments of this disclosure. As used herein, “server” refers to any suitable server, computer or computing device for performing functions utilized to practice embodiments of this disclosure. Users join a meeting via their preferred collaboration tool for e.g., MiTeam Meetings, Zoom, Microsoft Teams etc.

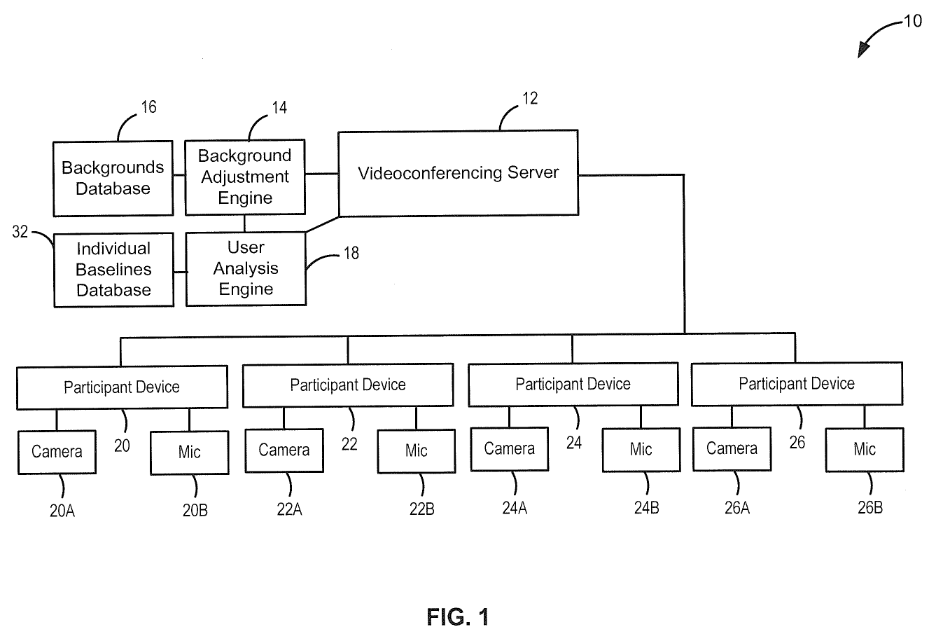

Turning now to the Figures, FIG. 1 shows a system 10 according to aspects of this disclosure. A videoconferencing server 12, which can be any type of server(s), computer(s), or processor(s), is in communication with an background adjustment engine 14, which can be any type of server(s), computer(s), or processor(s), that is in communication with and can access one or more backgrounds databases 16. Backgrounds database 16 can be, for example, the internet, one or more social media platforms, and/or one or more organizational databases. Background adjustment engine 14 is also in communication with user analysis engine 18. The user analysis engine 18 can in turn access an individual baselines database 32.

Videoconferencing server 12 is also in communication with one or more participant devices 20, 22, 24, and 26, each of which has a respective camera 20A, 22A, 24A, and 26A, and each of which also has a respective microphone 20B, 22B, 24B, and 26B. Videoconferencing server 12 generates a videoconference and makes it available to all participant devices 20, 22, 24, and/or 26 of participants in videoconference.

When system 10 is in use, videoconference server 12 causes a videoconference to be generated, which can be viewed by each respective participant of a participant device 20, 22, 24, and/or 26. Each participant may set their own virtual background for the videoconference. Alternatively, a participant may choose to have a “live” background, i.e. whatever is in the field of view of the camera. Each participant device 20, 22, 24, and 26 provides a video feed to the videoconference server 12 which includes the virtual or live background for display to other participants of the videoconference. Each participant device 20, 22, 24, and 26 also displays the video feed and background of the respective user of the participant device.

While existing systems may allow a participant to change their background before or during a meeting, this generally requires multiple user inputs to a GUI. Such updates are also the subjective choice of the participant. In contrast, the system and method disclosed herein analyses physical cues in the participant, which may be subtle and/or involuntary, and infers a cognitive or emotional state of the participant from these observations.

The user analysis engine 18 is configured to receive the video feeds from each participant device 20, 22, 24, and 26. The video feeds may be received via the videoconference server 12 or via the videoconference server 12 and background adjustment engine 14. The user analysis engine 18 is then configured to analyze one or more of the received video feeds to detect physical characteristics of the participants visible in the feeds. For example, the user analysis engine 18 analyzes a first video feed from a first participant device 20 to detect one or more physical characteristics of a first participant. The different physical characteristics which the user analysis engine 18 is programmed to detect and analyze are described in greater detail below.

After the user analysis engine 18 has detected one or more physical characteristics of the first participant, it is configured to infer a particular cognitive or emotional state of the first participant based on the detected one or more physical characteristics. The link between the detected physical characteristics and the inferred cognitive or emotional state is discussed in greater detail below, and may include inferring a negative state, such as of cognitive fatigue, stress, distractedness, disinterest, hyperstimulation, confusion or nervousness. In some embodiments, the user analysis engine 18 may infer a positive state such as attentiveness or heightened engagement.

In some embodiments, in order to infer a particular cognitive or emotional state of the first participant, the user analysis engine 18 first accesses an individual baselines database 32. The individual baselines database 32 has been previously populated with data specific to some or all of the participants of the videoconference to provide baseline metrics of physical characteristics and behaviours for respective participants. The user analysis engine 18 retrieves the data relating to the first participant and compares the detected one or more physical characteristics with the baseline data. If the user analysis engine 18 determines a deviation from a baseline metric which exceeds a predetermined factor, it infers a corresponding cognitive or emotional state.

The user analysis engine 18 then provides information about the inferred cognitive or emotional state of the first participant to the background adjustment engine 14. The background adjustment engine 14 is configured to select a virtual background to be displayed with the video feed from the first participant device. This selection is made based on the information about the inferred cognitive or emotional state of the first participant. The particular inferred cognitive or emotional state of the first participant will therefore affect the kind of image that the background adjustment engine 14 selects for use. The background adjustment engine 14 may access a backgrounds database 16, or more than one backgrounds database and perform a query for suitable images.

The background adjustment engine 14 may then return the selected background image to the videoconference server 12 which replaces the existing background of the first participant with the selected image. The videoconference server 12 may also be configured to replace a “live” background with a virtual background, using the selected image.

As described above, the processing of the background adjustment method may be split between the various modules. In some embodiments, the background adjustment engine 14 may be the primary module in control of the process. The image feeds from the participant devices 20, 22, 24, and 26 may be transmitted to the user analysis engine 18 via the background adjustment engine 14 and the resulting inferred particular cognitive or emotional state may be communicated back to the background adjustment engine 14 from the user analysis engine 18. The background adjustment engine 14 may transmit the selected virtual background to the videoconferencing server 12 for display and may also transmit instructions which cause the videoconferencing server 12 to effect the change of background for the particular participant.

In some other embodiments, the videoconferencing server 12 is in primary control of the process. The background adjustment engine 14 and user analysis engine 18 may be provided as APIs. The background adjustment engine 14 and user analysis engine 18 may be running on separate servers, which may be remote from the videoconferencing server 12. In some other embodiments, the background adjustment engine 14 and/or user analysis engine 18 may be software modules running on the videoconferencing server 12. The backgrounds databases 16 and individual baselines database 32 may be located on the videoconferencing server 12, or may be remotely accessed by the videoconferencing server 52 or engines 14, 18.

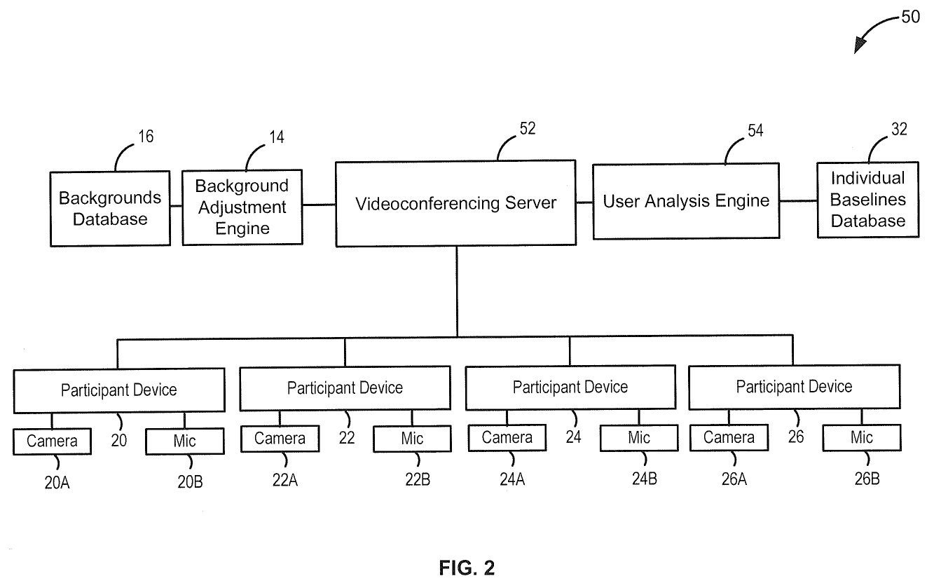

FIG. 2 shows an alternate system 50 according to aspects of this disclosure, which functions the same as system 10 except as described herein or shown in the Figures. System 50 includes a videoconferencing server 52 that is also configured to generate a videoconference. Videoconferencing server 52 is again in communication with one or more participant devices 20, 22, 24, and 26 and with background adjustment engine 14, which is in communication with and can access one or more backgrounds databases 16. In this embodiment, the user analysis engine 54 is in direct communication with the videoconferencing server 52 and in indirect communication with background adjustment engine 14 through videoconferencing server 52.

In the embodiment of FIG. 2, the videoconferencing server 52 is in control of the background adjustment method. The videoconferencing server 52 issues commands to the background adjustment engine 14 and to the user analysis engine 54 and receives responses and data from them accordingly. In particular, the videoconferencing server 52 receives the video feeds from each of the participant devices 20, 22, 24, and 26 and transmits at least one of these to the user analysis engine 54, which detects the physical characteristics and behaviors of the participants. In some embodiments, the user analysis engine 54 then infers a particular cognitive or emotional state of a participant based on the detected the physical characteristics and behaviors. In some other embodiments, the user analysis engine 54 first queries the individual baselines database 32 to retrieve baseline metrics for the participant in question. The user analysis engine 54 then infers a particular cognitive or emotional state if the detected physical characteristics and behaviors differ from the baseline metrics by more than a predetermined factor. The predetermined factor may differ for each type of physical characteristic and may be set in a memory portion of the user analysis engine 54 or the videoconferencing server 52.

After receiving information related to the inferred particular cognitive or emotional state from the user analysis engine 54, the videoconferencing server 52 passes this information to the background adjustment engine 14. The background adjustment engine 14 then selects a virtual background to be displayed behind the participant in question based on the inferred particular cognitive or emotional state of that participant. The background adjustment engine 14 may query one or more backgrounds databases 16, which store images having metadata indicating the content of the image. For example, the metadata may indicate the primary subject of the image, any secondary subjects of the image, one or more categories of the image, a colour pallet and/or list of principal colours used and/or a visual complexity of the image. The background adjustment engine 14 may retrieve several images from one or more backgrounds databases 16 and then make a selection from these to transmit back to the videoconferencing server 52. After receiving the selected background image from the background adjustment engine 14, the videoconferencing server 52 renders this behind the video feed of the participant in question within the videoconference.

Although the user analysis engine 54. background adjustment engine 14, individual baselines database 32 and backgrounds databases 16 have been shown as separate modules in FIG. 2, one or more of these may instead be an integral part of the videoconferencing server 52. For example, the background adjustment engine 14 and/or user analysis engine 54 may be software modules running on a processing architecture of the videoconferencing server 52. The individual baselines database 32 and/or the backgrounds databases 16 may also be part of memory of the videoconferencing server 52. Where the backgrounds databases 16 is part of the videoconferencing server 52, the videoconferencing server 52 may still access further external image databases to retrieve potential virtual background images.

As mentioned above, the user analysis engine 18 is configured to analyze one or more of the received video feeds to detect physical characteristics of the participants visible in the feeds. A range of different physical characteristics, behaviours and cues may be detectable by the user analysis engine 18.

(A) The user analysis engine 18 may measure a blink rate of the participant. The user analysis engine 18 may measure both the blink rate (i.e. the periodicity of blinks) and the blink duration (i.e. the time to complete one blink), or only one of these metrics. The user analysis engine 18 may split the video into multiple time periods and compare the blink rate and/or blink duration observed in different time periods. In this manner, the user analysis engine 18 can determine a variation in blink rate and/or duration of the participant.

The user analysis engine 18 may compare the measured blink rate and duration with predetermined thresholds. For example, a high threshold and a low threshold may be set for both blink rate and blink duration. As another example, only a high threshold may be set for both blink rate and blink duration. As used herein the term “high threshold” means a threshold value which is deemed exceeded if the measured value is higher than the high threshold value and a “low threshold” means a threshold value which is deemed exceeded if the measured value is lower than the low threshold value. Alternatively, the user analysis engine 18 may query the individual baselines database 32 to retrieve baseline metrics for blink rate and/or blink duration and optionally the natural variations in these for the particular participant in the video being analyzed.

Having measured the blink rate and/or blink duration, the user analysis engine 18 compares these with the predetermined high and/or low thresholds and if they exceed one of the thresholds the user analysis engine 18 infers that the user is stressed and/or cognitively fatigued. Alternatively, the user analysis engine 18 compares the measured blink rate and/or blink duration with the individual baseline metrics retrieved from the individual baselines database 32.

An increased blink rate can be used to infer a state of cognitive fatigue, tiredness and/or stress. An increased blink duration can be used to infer a state of cognitive fatigue or tiredness. The user analysis engine 18 may determine a factor or an absolute value by which the blink rate and/or blink duration should differ from the baseline metrics in order for the state of cognitive fatigue, tiredness and/or stress to be inferred. For example, the factor may be in the range of 40-100%, or more particularly 40-90%, or more particularly still 40-75%. Alternatively, an absolute value of 25 blinks per minute or 30 blinks per minute may be set as the high threshold for blink rate, or a difference of more than 10 blinks per minute above the particular user's baseline blink rate. An absolute value for blink duration of between 500¬1000 ms may be set as the high threshold for blink duration.

The user analysis engine 18 then feeds an inferred state of cognitive fatigue and/or stress for the particular participant back to the videoconferencing server 12 or background adjustment engine 14 and the background adjustment engine 14 selects an image to be used as the virtual background for the particular participant. This may comprise the background adjustment engine 14 relating the inferred cognitive or emotional state to one or more image characteristics which are used to search for images which are considered beneficial for the particular cognitive or emotional state. For example, if the inferred cognitive or emotional state is stress then the background adjustment engine 14 may search for images considered to be calming. Such images may have metadata tags specifically indicating them as “calming”, or indicating their content, such as natural landscapes or environments, bodies of water, repeating patterns, geometrical patterns or minimalist designs. The metadata may also indicate a colour pallet and/or primary colour of the image.

(B) The user analysis engine 18 may measure saccadic eye movements of the participant. Saccadic eye movements are involuntary jumps in gaze direction which occur naturally. But if the frequency of saccadic eye movement is high or if the movement is highly erratic, this can signal distractedness, stress or hyperstimulation. The user analysis engine 18 may measure the rate of saccadic eye movements, i.e. number of saccades per minute. The user analysis engine 18 may also measure the average size of a saccade, e.g. in degrees.

The user analysis engine 18 may compare the measured frequency of saccadic eye movement and optionally the measured size of saccadic eye movement with predetermined thresholds. One or more high thresholds may be set for both frequency of saccadic eye movement and size of saccadic eye movement. As used herein the term “high threshold” means a threshold value which is deemed exceeded if the measured value is higher than the high threshold value.

Having measured the frequency of saccadic eye movement and/or the measured size of saccadic eye movement, the user analysis engine 18 compares these with one or more predetermined high thresholds and if they exceed these the user analysis engine 18 infers a cognitive or emotional state of distractedness, stress or hyperstimulation. The degree to which the measured frequency of saccadic eye movement and/or the measured size of saccadic eye movement exceeds the thresholds may determine which of the cognitive or emotional states is inferred. For example, a higher threshold may be set for stress than distractedness and a higher threshold may be set for hyperstimulation than for stress.

Alternatively, the user analysis engine 18 may query the individual baselines database 32 to retrieve baseline metrics for frequency of saccadic eye movement and/or the measured size of saccadic eye movement and optionally the natural variations in these for the particular participant in the video being analyzed and compare the measured values with these baselines. The user analysis engine 18 then determines the extend to which the measured frequency of saccadic eye movement and optionally the measured size of saccadic eye movement differs from the baseline metrics.

A high frequency of saccadic eye movement can be used to infer a state of distractedness or stress. However, a “normal” rate of saccadic eye movement may be highly dependent on what the participant is looking at. The user analysis engine 18 (or the videoconferencing server 12) may be configured to determine whether or not a screen is being shared in the videoconference and whether there is any writing on the screen being shared and to adjust the high threshold for saccadic eye movement accordingly. In a situation where the participant is viewing their own video feed and/or at least one other video feed showing another participant and their virtual background, the user analysis engine 18 can assume that the participant is not reading and to set a “normal visual scanning” high threshold.

Erratic saccades may also be used to infer a state of stress or hyperstimulation. The user analysis engine 18 may determine that saccades are erratic by measuring the average size of saccades (e.g. in degrees) within a time period. If the average saccade size is greater than a predetermined high threshold, a cognitive or emotional state of stress or hyperstimulation is inferred. More sophisticated ways of determining how erratic the observed saccades are may be employed, such as combining information on saccade frequency, saccade duration, saccade size and/or specific saccade direction.

The user analysis engine 18 then feeds an inferred state of distractedness, stress or hyperstimulation back to the videoconferencing server 12 or background adjustment engine 14 and the background adjustment engine 14 selects an image to be used as the virtual background for the particular participant. This may comprise the background adjustment engine 14 relating the inferred cognitive or emotional state to one or more image characteristics which are used to search for images which are considered beneficial for the particular cognitive or emotional state. For example, if the inferred cognitive or emotional state is distractedness then the background adjustment engine 14 may search for images considered to help enhance focus. Such images may have metadata tags specifically indicating them as “focus-enhancing”, or indicating their content, such as repeating patterns, geometrical patterns, minimalist designs or images of cityscapes or buildings. The metadata may also indicate a colour pallet and/or primary colour of the image.

(C) The user analysis engine 18 may measure facial muscle tension. This may extend to muscles is the neck. Minor changes in facial muscle tension, particularly around the eyes, mouth and jaw, can indicate stress or frustration. These changes may be subtle and/or involuntary.

The user analysis engine 18 may measure the overall level of facial muscle tension or may measure specific levels of facial muscle tension in separate facial areas, such as around the eyes, around the mouth and/or in the jaw. If the overall measured level of facial tension is elevated, i.e. exceeds a predetermined threshold, the user analysis engine 18 infers a cognitive or emotional state of stress or confusion. The user analysis engine 18 may only infer this cognitive state if the overall measured level of facial tension exceeds a predetermined threshold for a given time period, i.e. if the muscle tension is prolonged.

Alternatively, the user analysis engine 18 may measure specific levels of facial muscle tension in separate facial areas. For example, two different areas may be defined, (i) around the eyes and (ii) around the mouth, since these are easily distinguished from one another by computer vision. If the level of muscle tension in either one of these regions exceeds a predetermined threshold, the user analysis engine 18 infers a cognitive or emotional state of stress or confusion. Alternatively, the thresholds must be exceeded in both regions.

The user analysis engine 18 may be configured to distinguish between different cognitive or emotional states, for example to distinguish whether the user is stressed, or merely confused by analysing the muscle tension around the eyes and around the mouth.

The user analysis engine 18 may access images of the particular participant from the individual baselines database 32 and perform a comparison of still images extracted from the video feed with the images from the individual baselines database 32. In this manner, a comparison with a baseline image of the participant is performed. The user analysis engine 18 may perform the analysis based on a model. The user analysis engine 18 may convert still images extracted from the video feed to a wireframe model using computer vision techniques. The baseline images (if used) may also be converted to wireframe model for comparison, or may already be stored in the individual baselines database 32 as wireframe models. Distances between nodes in the wireframe model may be used to estimate muscle tension. The parameters of the model may be defined from first principles. Alternatively, the model may be a Machine Learned model which has been trained on a training set of images depicting human faces. Each training image may have metadata indicating whether the face depicted is considered stressed, confused, or relaxed, for example.

The user analysis engine 18 then feeds an inferred state of stress or confusion for the particular participant back to the videoconferencing server 12 or background adjustment engine 14 and the background adjustment engine 14 selects an image to be used as the virtual background for the particular participant. This may comprise the background adjustment engine 14 relating the inferred cognitive or emotional state to one or more image characteristics which are used to search for images which are considered beneficial for the particular cognitive or emotional state. For example, if the inferred cognitive or emotional state is stress then the background adjustment engine 14 may search for images considered to be calming. Such images may have metadata tags specifically indicating them as “calming”, or indicating their content, such as natural landscapes or environments, bodies of water, repeating patterns, geometrical patterns or minimalist designs. The metadata may also indicate a colour pallet and/or primary colour of the image.

(D) The user analysis engine 18 may measure gaze direction. In particular, the user analysis engine 18 may determine whether the participant is looking at their screen or away from their screen. Prolonged periods of looking away from their screen can indicate distractedness (perhaps due to external distractions) or lack of concentration.

The user analysis engine 18 can detect the participant's gaze direction from analysing the video feed. This may be done in a similar way to the saccadic eye movement detection discussed above. However, for the purpose of gaze direction analysis, the saccadic eye movements may be ignored, or otherwise filtered out, to determine a general gaze direction. The user analysis engine 18 may then determine whether the gaze direction of the participant is away from the screen or not. If the participant's gaze is determined to be away from the screen, the user analysis engine 18 infers a cognitive or emotional state of distractedness. The user analysis engine 18 may only infer this cognitive state if the participant's gaze is away from the screen for more than a predetermined time.

The user analysis engine 18 then feeds an inferred state of distractedness back to the videoconferencing server 12 or background adjustment engine 14 and the background adjustment engine 14 selects an image to be used as the virtual background for the particular participant. This may comprise the background adjustment engine 14 relating the inferred cognitive or emotional state to one or more image characteristics which are used to search for images which are considered beneficial for the particular cognitive or emotional state. For example, if the inferred cognitive or emotional state is distractedness then the background adjustment engine 14 may search for images considered to help enhance focus and to re-engage the participant. Such images may have metadata tags specifically indicating them as “focus-enhancing”, or indicating their content, such as repeating patterns, geometrical patterns, minimalist designs or images of cityscapes or buildings. The metadata may also indicate a colour pallet and/or primary colour of the image.

(E) The user analysis engine 18 may be configured to detect repetitive gestures made by a participant. For example, the user analysis engine 18 may detect tapping or fidgeting, e.g. tapping a finger or other object against the face. Such repetitive gestures might indicate nervousness or distractedness. The user analysis engine 18 may be configured to detect these kinds of physical characteristics by converting still images extracted from the video feed into a wireframe model, as described above in relation to facial muscle tension. Alternatively, a different computer vision technique may be used.

When the user analysis engine 18 detects repetitive gestures made by a participant, it infers a cognitive or emotional state of distractedness or nervousness. The user analysis engine 18 may only infer this cognitive state if the repetitive gesture occurs several times, or several times within a given timeframe.

The user analysis engine 18 then feeds an inferred state of distractedness or nervousness back to the videoconferencing server 12 or background adjustment engine 14 and the background adjustment engine 14 selects an image to be used as the virtual background for the particular participant. This may comprise the background adjustment engine 14 relating the inferred cognitive or emotional state to one or more image characteristics which are used to search for images which are considered beneficial for the particular cognitive or emotional state. For example, if the inferred cognitive or emotional state is nervousness then the background adjustment engine 14 may search for images for images considered to be re-assuring or calming. Such images may have metadata tags specifically indicating them as “calming”, or indicating their content, such as natural landscapes or environments, bodies of water, repeating patterns, geometrical patterns or minimalist designs. The metadata may also indicate a colour pallet and/or primary colour of the image.

(F) The user analysis engine 18 may measure shifts in body posture. In particular, the user analysis engine 18 may determine whether the participant is leaning forwards or leaning backwards, slouching or any significant change between these positions. Prolonged periods of leaning backwards or slouching can indicate distractedness or disinterest.

The user analysis engine 18 can detect the participant's body posture and changes in body posture using computer vision techniques, for example 3D pose estimation.

The user analysis engine 18 is configured to extract still images from the video feed of the participant and to estimate the body posture of the participant. In some embodiments, the result of the analysis may be a state of “leaning forward”, “leaning backward” or “slouching”. If the participant's posture is determined to be “leaning backward” or “slouching”, the user analysis engine 18 infers a cognitive or emotional state of distractedness or disinterest. The user analysis engine 18 may only infer this cognitive state if the participant's posture is “leaning backward” or “slouching” for more than a predetermined time.

The user analysis engine 18 then feeds an inferred state of distractedness or disinterest back to the videoconferencing server 12 or background adjustment engine 14 and the background adjustment engine 14 selects an image to be used as the virtual background for the particular participant. This may comprise the background adjustment engine 14 relating the inferred cognitive or emotional state to one or more image characteristics which are used to search for images which are considered beneficial for the particular cognitive or emotional state. For example, if the inferred cognitive or emotional state is distractedness then the background adjustment engine 14 may search for images considered to help enhance focus and to re-engage the participant. Such images may have metadata tags specifically indicating them as “focus-enhancing”, or indicating their content, such as repeating patterns, geometrical patterns, minimalist designs or images of cityscapes or buildings. The metadata may also indicate a colour pallet and/or primary colour of the image.

(G) The user analysis engine 18 may measure adjustments in head position. In particular, the user analysis engine 18 may determine whether the participant's head is leaning forwards, backwards or to one side, or any significant change between these positions. Prolonged periods of any of these states can indicate confusion. Additionally, small adjustments in head position may be indicative of confusion, or alternatively of concentration.

The user analysis engine 18 can detect the participant's head position and/or small adjustments in the participant's head position using computer vision techniques, for example 3D pose estimation. The user analysis engine 18 is configured to extract still images from the video feed of the participant and to estimate the head position of the participant. The user analysis engine 18 may then infers a cognitive or emotional state of confusion.

The user analysis engine 18 then feeds an inferred state of confusion back to the videoconferencing server 12 or background adjustment engine 14 and the background adjustment engine 14 selects an image to be used as the virtual background for the particular participant. This may comprise the background adjustment engine 14 relating the inferred cognitive or emotional state to one or more image characteristics which are used to search for images which are considered beneficial for the particular cognitive or emotional state. For example, the background adjustment engine 14 may search for images considered to help enhance focus and to re-engage the participant. Such images may have metadata tags specifically indicating them as “focus-enhancing”, or indicating their content, such as repeating patterns, geometrical patterns, minimalist designs or images of cityscapes or buildings. Alternatively, the background adjustment engine 14 may search for images for images considered to be re-assuring or calming. Such images may have metadata tags specifically indicating them as “calming”, or indicating their content, such as natural landscapes or environments, bodies of water, repeating patterns, geometrical patterns or minimalist designs. The metadata may also indicate a colour pallet and/or primary colour of the image.

The user analysis engine 18 may simultaneously measure more than one of the above discussed physical characteristics. This may lead to the user analysis engine 18 inferring multiple cognitive or emotional states of a participant, some of which may be duplicates. If the user analysis engine 18 infers multiple different cognitive or emotional states, the user analysis engine 18 may additionally assess which of the physical characteristics exceeds the normal value or the individual's baseline metric by the greatest degree and use only this physical characteristic to infer the cognitive or emotional state. Alternatively, the user analysis engine 18 may return multiple inferred cognitive or emotional states to the background adjustment engine 14 or videoconferencing server 12, which may then select a new background image accordingly.

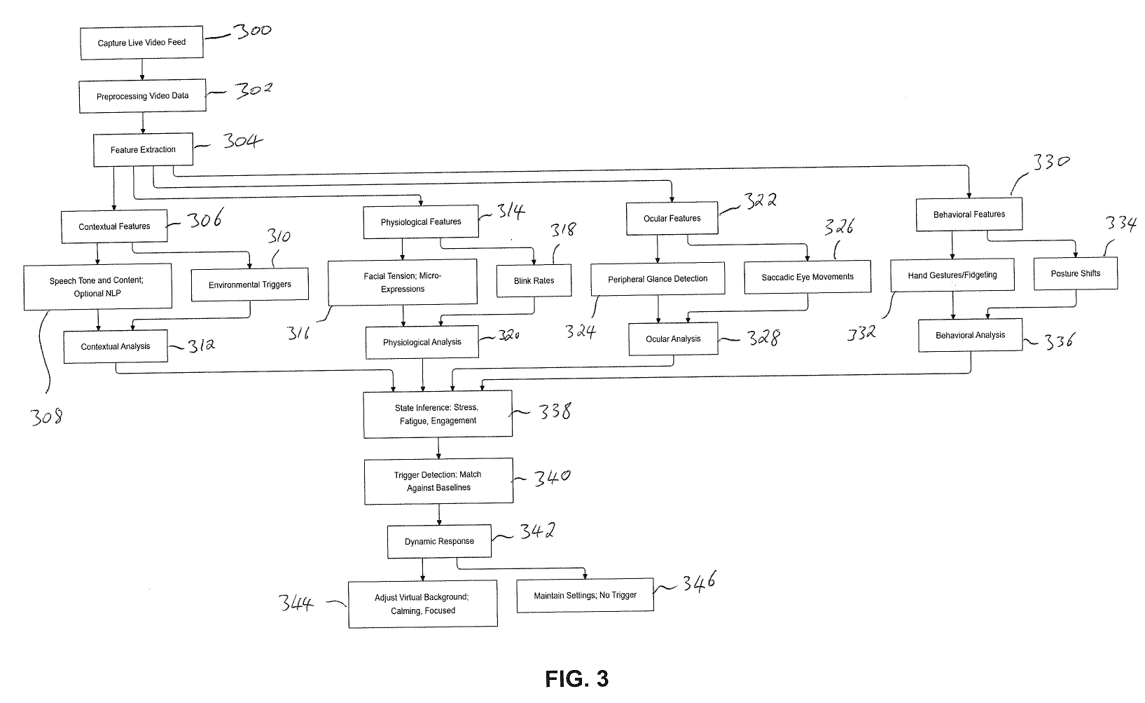

FIG. 3 is a flowchart illustrating the different kinds of physical characteristics which may be detected with the present method. At step 300 video data is captured by the cameras 20A, 20B, 20C, 20D of the participant devices. At step 302 the video data is preprocessed. This may occur on the participant devices 20, 22, 24, 26 and/or on the videoconference server 12 and/or user analysis engine 18.

At step 304 the video data is received at the user analysis engine 18 for feature extraction. The various kinds of feature extraction described in the embodiments above have been grouped into physiological features 314, ocular features 322 and behavioural features 330. In addition, the user analysis engine 18 may also receive and analyze audio from the participant devices 20, 22, 24, 26 and extract contextual features 306 from the audio in order to infer a cognitive or emotional state of the participant. For example, in step 308, the speech tone and content may be analysed. This may be done by analysing the audio content directly or by employing natural language processing. The audio may first be converted to text for the NLP to be applied. Any NLP is used to supplement the physical characteristic detection, identifying verbal cues that may align with or contradict the detected physical signals, increasing accuracy in identifying participant discomfort or distress. For example, if a verbal cue indicating confusion is detected within a short time period of a physical characteristic indicating confusion, the user analysis engine 18 may infer this cognitive or emotional state more strongly or with greater confidence.

At step 310 the user analysis engine 18 may also detect environmental triggers such as external noises which are deemed not to be speech. If a detected physical characteristic coincides with a distracting environmental trigger the physical characteristic may be ignored or given less weight in the analysis. At step 312 the detected contextual features are analysed. As discussed above this is done in conjunction with the physical characteristics to optionally supplement the inferences based on the physical characteristics.

The physiological features 314 may be subdivided into facial tension and micro expressions 316 and blink rate and duration 318. These features are generally considered to be involuntary and subtle, which distinguishes them from the behavioural features 330. At step 320 the detected physiological features are analysed and any cognitive or emotional states are inferred.

The ocular features 322 may be subdivided into peripheral glance detection 324 (which may be considered the same as gaze direction detection) and saccadic eye movements 326. At step 328 the detected ocular features are analysed and any cognitive or emotional states are inferred.

The behavioural features 330 may be subdivided into gestures (such as hand gestures) 332 and posture shifts 334, such as leaning forwards/backwards and head position adjustments. These features are generally considered to be at least pseudo-voluntary, although a participant may do them subconsciously and are less subtle than facial micro-expressions and muscle tension. At step 336 the detected behavioral features are analysed and any cognitive or emotional states are inferred.

At step 338 any and all cognitive or emotional states are inferred from the various physical and verbal characteristics. This may comprise comparing the degrees to which certain physical characteristics are considered to infer a particular cognitive or emotional state and selecting the most likely state. At optional step 340 the user analysis engine 18 may consult individual baselines database 32 before making any cognitive or emotional state inference or when comparing inferences derived from different physical characteristics.

At step 342 a dynamic response is provided. This entails the background adjustment engine 14 receiving the cognitive or emotional state inferences(s) and selecting a virtual background accordingly, as described above. At step 344 the videoconference server 12 may adjust the virtual background of the affected participant using the image provided by the background adjustment engine 14. If the result of step 338 is that no particular negative cognitive or emotional state is inferred, then at step 346 the current background setting for the participant are maintained.

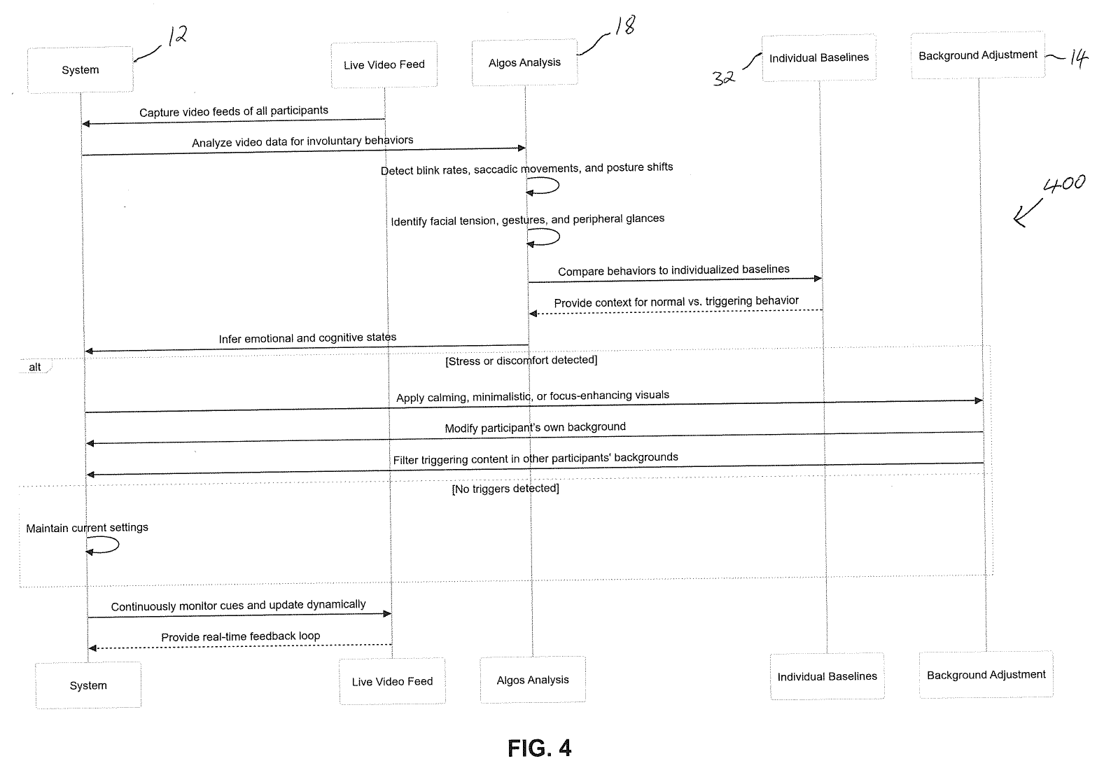

FIG. 4 is a sequence diagram 400 showing signals sent between various parts of the system 100 to implement the embodiments described herein. The participant devices capture and send video to the system, which may be embodied by the videoconference server 12. The system provides the video to the analysis module, which may be embodied by the user analysis engine 18, 54. The user analysis engine then detects one or more of blink rates, blink duration, saccadic eye movements, posture shifts, facial muscle tension, repetitive gestures and peripheral glances. The user analysis engine may then access or query the individual baselines database 32 which may return information providing context for normal behaviour for that participant and allow the user analysis engine to compare the detected behaviours to individualized baselines.

The user analysis engine 18, 54 then infers a cognitive or emotional state and provides this result to the background adjustment engine 14. The background adjustment engine selects an appropriate image based on the inferred cognitive or emotional state and provides the image back to the system.

The system continuously monitors participants' behavioral cues, dynamically updating virtual backgrounds throughout the meeting to promptly address any new triggers or changes in emotional or cognitive states, ensuring an adaptive and responsive environment.

While this system and method is primarily aimed at adjusting a participant's own background to enhance focus, reduce cognitive load, and create a calming environment tailored to each participant's current state, the system may also make changes to the backgrounds of other participants which are visible to the participant which has been analysed. At this point the system may also filter out or replace the content in other participant's backgrounds if it is deemed to be contributing or triggering the cognitive or emotional state in the participant. For example, the system may filter out rapid flashing images, intense staring or unsettling visuals or any other backgrounds that may cause discomfort or distraction for participants sensitive to visual stimuli. Participants can set preferences specifying known triggers or content to avoid and have the ability to opt in or out of personalization features.

As can be appreciated from the foregoing description, this system introduces an innovative method that dynamically personalizes virtual backgrounds in real-time by analyzing subtle, involuntary physical cues indicative of a participant's emotional and cognitive state. By using computer vision techniques and machine learning algorithms, the system monitors micro-behaviors such as blink-rates, saccadic eye movements, facial tension, and posture shifts. Unlike previous solutions that focus on manual background selection, this approach prioritizes user well-being and engagement. The virtual background adapts to enhance focus, reduce cognitive load, and create a calming environment tailored to each user's current state, thereby improving the overall success of virtual meetings. In this manner, the system is not detecting a user preference, but rather is detecting underlying and potentially involuntary sentiment and then implementing a measure to counteract it.

The above method is particularly useful for mitigating exposure to triggering content for participants with mental health sensitivities (e.g., schizophrenia, anxiety disorders). It also provides therapeutic and calming virtual environments that reduce stress or discomfort because visuals are selected specifically to enhance overall participant well-being by adjusting visual environments in real-time based on sentiment detection. The system provides an individualized experience for each user, moving beyond generic or static backgrounds. Additionally, measuring involuntary micro-behaviors permit the assessment of a user's state without requiring active input or causing discomfort.

The description of embodiments provided herein is merely exemplary and is intended for purposes of illustration only. The methods and systems according to this disclosure and claims can operate in a premise, cloud-based, or hybrid environment.

The features of the various embodiments may be stand alone or combined in any combination. Further, unless otherwise noted, various illustrated steps of a method can be performed sequentially or at the same time, and not necessarily be performed in the order illustrated. It will be recognized that changes and modifications may be made to the exemplary embodiments without departing from the scope of the present invention. These and other changes or modifications are intended to be included within the scope of the present invention, as expressed in the following claims.

1. A videoconferencing system configured to generate a video conference including a background for one or more participants of the videoconference, the videoconferencing system comprising:
a background adjustment engine;
a user analysis engine; and
a videoconferencing server in communication with the background adjustment engine and configured to generate a videoconference and communicate the video conference to one or more conference participant devices,
wherein the user analysis engine is configured to:
receive a video feed from each of the one or more participant devices;
analyze a first video feed from a first of the one or more participant devices to detect one or more physical characteristics of a first participant; and
infer a particular cognitive or emotional state of a first participant based on the detected one or more physical characteristics,
and wherein the background adjustment engine is configured to select a virtual background to be displayed with the first video feed based on the particular cognitive or emotional state of the first participant.

2. The videoconferencing system of claim 1, wherein the background adjustment engine is configured to obtain one or more images from a backgrounds database, the one or more images being selected based on the particular cognitive or emotional state of the first participant.

3. The videoconferencing system of claim 2, wherein the background adjustment engine is configured to select a virtual background displayed with the first video feed by instructing the videoconferencing server to display one of the one or more images obtained from the backgrounds database as the virtual background displayed with the first video feed.

4. The videoconferencing system of claim 2, wherein the one or more images are selected using metadata indicating that the one or more images are considered beneficial for the particular cognitive or emotional state.

5. The videoconferencing system of claim 1, wherein the user analysis engine is configured to infer the particular cognitive or emotional state of the first participant by associating the detected one or more physical characteristics of a first participant with cognitive fatigue, stress, confusion, distractedness and/or nervousness.

6. The videoconferencing system of claim 1, wherein the user analysis engine is configured to detect the one or more physical characteristics of a first participant by measuring a blink rate and/or a blink duration.

7. The videoconferencing system of claim 6, wherein:
in response to detecting a variation in at least one of a blink rate or blink duration, or in response to detecting at least one of a blink rate or duration which is above a high threshold, the user analysis engine is configured to infer a state of cognitive fatigue and/or stress of the first participant; and
the background adjustment engine is configured to select a virtual background to be displayed with the first video feed based on the inferred state of cognitive fatigue and/or stress.

8. The videoconferencing system of claim 1, wherein the user analysis engine is configured to detect the one or more physical characteristics of a first participant by tracking saccadic eye movements.

9. The videoconferencing system of claim 8, wherein:
in response to detecting saccadic eye movements which are at least one of erratic or high in frequency, the user analysis engine is configured to infer a state of distractedness, stress or hyperstimulation; and
the background adjustment engine is configured to select a virtual background to be displayed with the first video feed based on the inferred state of distractedness, stress or hyperstimulation.

10. The videoconferencing system of claim 1, wherein the user analysis engine is configured to detect the one or more physical characteristics of a first participant by detecting changes in facial muscle tension.

11. The videoconferencing system of claim 10, wherein:
in response to detecting elevated or prolonged tension in the muscles around the eyes and/or jaw of the first participant, the user analysis engine is configured to infer a state of stress or confusion; and
the background adjustment engine is configured to select a virtual background to be displayed with the first video feed based on the inferred state of stress or confusion.

12. The videoconferencing system of claim 1, wherein the user analysis engine is configured to detect the one or more physical characteristics of a first participant by determining a gaze direction or change in a gaze direction.

13. The videoconferencing system of claim 12, wherein:
in response to detecting that the gaze direction of the first participant is away from the screen, the user analysis engine is configured to infer a state of distractedness; and
the background adjustment engine is configured to select a virtual background to be displayed with the first video feed based on the inferred state of distractedness.

14. The videoconferencing system of claim 1, wherein:
the user analysis engine is configured to detect the one or more physical characteristics of a first participant by detecting repetitive gestures and in response to infer a state of distractedness or nervousness; and
the background adjustment engine is configured to select a virtual background to be displayed with the first video feed based on the inferred state of distractedness or nervousness.

15. The videoconferencing system of claim 1, wherein the user analysis engine is configured to detect the one or more physical characteristics of a first participant by detecting a shift in body posture and wherein:
in response to detecting a shift in the body posture of the first participant to leaning backwards, the user analysis engine is configured to infer a state of distractedness and/or disinterest of the first participant; and
the background adjustment engine is configured to obtain an image from a backgrounds database, based on the inferred state of distractedness and/or disinterest.

16. The videoconferencing system of claim 1, wherein
the user analysis engine is configured to:
compare the detected one or more physical characteristics of the first participant with one or more corresponding baseline metrics for the first participant; and
infer the particular cognitive or emotional state of the first participant when the detected one or more physical characteristics differ from the one or more corresponding baseline metrics by a predetermined factor.

17. The videoconferencing system of claim 1, wherein the video feed is a live video feed and wherein the background adjustment engine is configured to replace a live feed background of the first live video feed with a virtual background selected based on the particular cognitive or emotional state of the first participant.

18. The videoconferencing system of claim 1, wherein in response to the user analysis engine inferring a particular cognitive or emotional state of a first participant, the background adjustment engine is configured to change a background displayed with a video feed of another of the one or more participants of the videoconference.

19. A videoconferencing method operable on a video conferencing system, wherein the videoconferencing method is configured to generate a video conference including a background for one or more participants of the videoconference and wherein the videoconferencing system comprises a videoconferencing server in communication with a background adjustment engine, and a user analysis engine, the method comprising the steps of:
the videoconferencing server generating a videoconference and communicating the video conference to one or more conference participant devices;
the user analysis engine receiving a video feed from each of the one or more participant devices;
the user analysis engine analyzing a first video feed from a first of the one or more participant devices to detect one or more physical characteristics of a first participant;
the user analysis engine inferring a particular cognitive or emotional state of a first participant based on the detected one or more physical characteristics; and
the background adjustment engine selecting a virtual background to be displayed with the first video feed based on the particular cognitive or emotional state of the first participant.

20. A videoconferencing system configured to generate a video conference including a background for one or more participants of the videoconference, the videoconferencing system comprising:
a background adjustment engine;
a user analysis engine; and
a videoconferencing server in communication with the background adjustment engine and configured to generate a videoconference and communicate the video conference to one or more conference participant devices,
wherein the user analysis engine is configured to:
receive a video feed from each of the one or more participant devices;
analyze a first video feed from a first of the one or more participant devices to detect one or more physical characteristics of a first participant; and
infer a negative cognitive or emotional state of a first participant based on the detected one or more physical characteristics,
wherein the background adjustment engine is configured to change a virtual background to be displayed with the first video feed in response to the user analysis engine inferring the negative cognitive or emotional state,
and wherein the background adjustment engine is configured not to change the virtual background to be displayed with the first video feed in response to the user analysis engine not inferring the negative cognitive or emotional state.
